(19) United States
(12) Patent Application Publication
(10) Pub. No.: US 2003/0012416 A1
(43) Pub. Date: Jan. 16, 2003

(54) Fingerprint imaging device

(76) Inventors: Alexandre Ryabov, Gagrebssky blv. (RU); Yury Shapiro, San Ramon, CA (US)

Correspondence Address: FISH & RICHARDSON P.C., 500 ARGUELLO STREET, SUITE 500, REDWOOD CITY, CA, 94063, US

(21) Appl. No.: 09/915,754

(22) Filed: Jul. 27, 2001

Related U.S. Application Data
(63) Continuation-in-part of application No. 09/571,741, filed on May 15, 2000.

(51) Int. Cl. G06K 9/00

(52) U.S. Cl. 382/124

(57) ABSTRACT

A fingerprint imaging device includes an optical plate and an imaging system. The optical plate includes an optically-transparent base having a first surface covered with an array of microstructures and a coating deposited on the first surface for receiving a finger. To enable fingerprint imaging, the coating has an index of refraction that is different from the index of refraction of the base.

### CROSS REFERENCE TO RELATED APPLICATIONS

This application is a continuation-in-part of U.S. application Ser. No. 09/571,741, filed May 15, 2000 and titled “FINGERPRINT IMAGING DEVICE,” which is incorporated herein by reference.

### TECHNICAL FIELD

This invention relates to fingerprint imaging devices and methods of imaging fingerprints.

### BACKGROUND

Referring to FIG. 1, one type of fingerprint imaging device 100 includes a transparent optical plate 105 (for example, a prism) having a surface 107 exposed to air, a light source 110 located to the side of or near the optical plate 105, and an imaging system 112. The imaging system 112 includes an aperture 115, an objective 120, and some type of detector 125 (for example, a CCD or a CMOS camera). The interface between the surface 107 and the air is defined by a critical angle θ_{CR}, which is the smallest angle of incidence for which light striking the interface is totally internally reflected within the surface 107. The critical angle θ_{CR} at this interface depends on the indices of refraction of the air and the optical plate 105. The size of the surface 107 is typically greater than or equal to about 16 millimeters (mm) in both dimensions to enable accurate fingerprint identification. In one implementation, the surface 107 is about 18 mm in length and about 18 mm in width. For further reference, directions x and y of the orthogonal coordinate system are shown by arrows. A third direction z of this orthogonal coordinate system is perpendicular to the drawing plane of FIG. 1.

Referring also to FIG. 2, in operation, a finger 200 to be imaged is placed on the surface 107 and is illuminated by the light source 110 near the optical plate 105. Light from the light source 110 is incident on the surface 107 of the optical plate 105 at an angle of incidence measured with respect to a normal to the surface 107. Light from the light source 110 that strikes the surface 107 at an angle greater than the critical angle θ_{CR} is totally internally reflected from the surface 107.

As shown, the finger 200 includes a series of ridges 205 and intermediate valleys 210. Thus, when the finger 200 is applied to the surface 107, the ridges 205 contact the surface 107 of the optical plate 105 while the valleys 210 do not. Thus, the valleys 210 serve to form the pockets or regions of air and/or moisture. Some light rays 215 strike a portion of the surface 107 that is contacted by a ridge 205. Those light rays 215 are diffused because the index of refraction of the finger 200 is larger than the index of refraction of air. Some light rays 220 strike a portion of the surface 107 that is not contacted by a ridge 205 but is instead contacted by the pocket of air and/or moisture formed by a valley 210. If the angle of incidence of those light rays is greater than the critical angle, those light rays 220 are reflected from the surface 107 and reach the imaging system 112. In this way, the imaging system 112 detects a dark fingerprint image formed on a light background, called a positive image.

Referring to FIG. 3, another type of fingerprint imaging device 300 includes a transparent optical plate 305 (similar to optical plate 105) having a surface 307 exposed to air, one or more light sources 310 (similar to light source 110) located generally below the surface 307 of the optical plate 305, and an imaging system 312. The imaging system 312 includes an aperture 315 (similar to aperture 115), an objective 320 (similar to objective 120), and some type of detector 325. The interface between the surface 307 and the air is defined by a critical angle θ_{CR}, which is the smallest angle of incidence for which light striking the interface is totally internally reflected within the surface 307. The critical angle θ_{CR} at this interface depends on the indices of refraction of the air and the optical plate 305. The aperture 315 and objective 320 are configured to view the surface 307 at an angle greater than the critical angle θ_{CR}.

Referring also to FIG. 4, in operation, the finger 200 to be imaged is placed on the surface 307 and is illuminated by the one or more light sources 310. Light from a light source 310 is incident on the surface 307 of the optical plate 305 at an angle of incidence measured with respect to a normal to the surface 307. As discussed above, light from a light source 310 that strikes the surface 307 at an angle greater than the critical angle θ_{CR} is totally internally reflected from the surface 307. However, because the light sources 310 are located generally below the optical plate surface 307, a large portion of the light striking the surface 307 enters at an angle of incidence that is less than the critical angle θ_{CR}.

Some light rays strike a portion of the surface 307 that is contacted by a ridge 205. Those light rays are reflected and diffused because the index of refraction of the finger 200 is larger than the index of refraction of air. Thus, these light rays reach the detector 325.

Some light rays strike a portion of the surface 307 that is not contacted by a ridge 205 but is instead contacted by the pocket of air and/or moisture formed by a valley 210. However, because of the location of the light sources relative to the optical plate surface, the light striking the surface 307 enters at an angle of incidence that is less than the critical angle θ_{CR}. Accordingly, those light rays 220 are refracted through the surface 307, exit through the optical plate 305, and do not reach the detector 325. In this way, the detector 325 detects a light fingerprint image formed on a dark background, called a negative image.

Examples of fingerprint imaging devices are described in U.S. Pat. No. 4,924,085 to Kato et al.; U.S. Pat. No. 5,596,454 to Hebert; and U.S. Pat. No. 5,796,858 to Zhou et al. The size of the fingerprint imaging devices described in these patents exceeds the minimum require size of the finger receiving surface. Furthermore, the fingerprint imaging devices described in these patents are relatively thick, thus making it difficult to use these devices in portable or compact electronic apparatus.

### SUMMARY

In one general aspect, an imaging device includes an optical plate and an imaging system. The optical plate includes a base having a first surface, at least a portion of which is covered with an array of microstructures; a coating deposited on the first surface to form a finger-receiving surface; and a second surface. The optical plate is made of an optically transparent material and has an index of refraction. The coating has an index of refraction that is different from the index of refraction of the base. The imaging device also includes an imaging system positioned at the second surface to receive light from the finger at an observation angle measured relative the finger-receiving surface. The imaging system forms an image of a fingerprint pattern of the finger based on the received light.

Implementations may include one or more of the following features. For example, the base may include a third surface and the device may include a light source positioned the third surface to illuminate the first surface. The third surface may be perpendicular to the first surface.

The index of refraction of the coating may be less than the index of refraction of the base. The microstructure may include a surface that is substantially perpendicular to an observation path such that light from the finger strikes the microstructure surface at an angle substantially perpendicular to the microstructure surface.

The array of microstructures may be defined by a spatial period that is approximately two times greater than a maximum spatial period of ridges in an average fingerprint pattern.

The coating may include silicone. The base may include a spherically-shaped reflective surface positioned along a fourth surface that is approximately lateral to the first surface. The spherically-shaped reflective surface may collimate light from the finger onto the imaging system. The spherically-shaped reflective surface may be formed from a converging mirror or from a diverging mirror.

The imaging system may include an aperture at the second surface, an objective at the aperture, and a detector for receiving light collected by the aperture and the objective to form the image of the fingerprint pattern. The imaging system may include a reflective surface positioned between the objective and the detector for collecting light from the objective and for focusing the light onto the detector. The detector may include a CCD or a CMOS sensor. The aperture may define an aperture beam of light rays used by the detector to form the fingerprint pattern image.

The index of refraction of the coating may be greater than the index of refraction of the base. In this case, each microstructure may include a first surface and a second surface. The first and second surfaces are positioned such that light reflected from the coating and striking the first surface at an angle that is greater than the critical internal reflection angle for the coating and the base interface reflects from the first surface and strikes the second surface at an angle that substantially coincides with a normal to the second surface.

Aspects of the devices and systems can include one or more of the following advantages. The fingerprint imaging device may be used in portable or compact electronic apparatus because the size of the fingerprint imaging device can be reduced further without sacrificing fingerprint imaging quality.

Additionally, the elastic coating provides better conformation or improved optical contact with the finger.

The details of one or more implementations are set forth in the accompanying drawings and the description below. Other features and advantages will be apparent from the description, the drawings, and the claims.

### DESCRIPTION OF DRAWINGS

FIGS. 1-4 show fingerprint imaging devices known in the art.

FIGS. 5 and 6 show side sectional views of fingerprint imaging devices for use in an electronic apparatus.

FIG. 7 is a side sectional view of a scaled-up fragment of the fingerprint imaging device of FIG. 5.

FIG. 8 is a side sectional view of a scaled-up fragment of a fingerprint imaging device of FIG. 5 including an optical coating.

FIGS. 9A and 9B are side sectional views of a scaled-up fragment of a fingerprint imaging device of FIGS. 5 or 6.

FIG. 10 shows a fingerprint imaging device implemented in an electronic apparatus in which an optical coating has an index of refraction less than an index of refraction of an optical plate.

FIG. 11 is a side sectional view of a scaled-up fragment of the fingerprint imaging device of FIG. 10.

FIG. 12 shows a fingerprint imaging device implemented in an electronic apparatus in which an optical coating has an index of refraction greater than the index of refraction of the optical plate.

FIGS. 13 and 14 are side sectional views of scaled-up fragments of the fingerprint imaging device of FIG. 12.

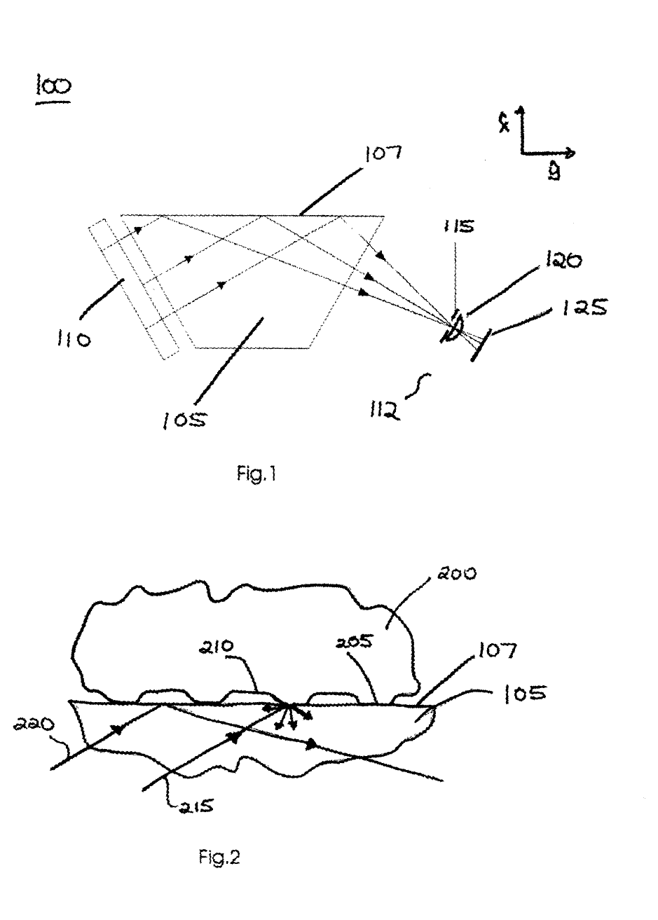

Like reference symbols in the various drawings indicate like elements.

### DETAILED DESCRIPTION

A fingerprint imaging device is designed with a reduced size with acceptable fingerprint image quality. Such a design may be useful not only in a standard imaging configuration, but also in a compact imaging configuration often incorporated into portable or compact electronic apparatus. Examples of portable or compact electronic apparatus include mobile telephones such as cellular or cordless telephones, personal computers such as portable computers, personal digital assistants, pagers, and remote control systems. Moreover, to reduce cost, the fingerprint imaging device may be built into the electronic apparatus with substantially no changes in the design of these apparatus.

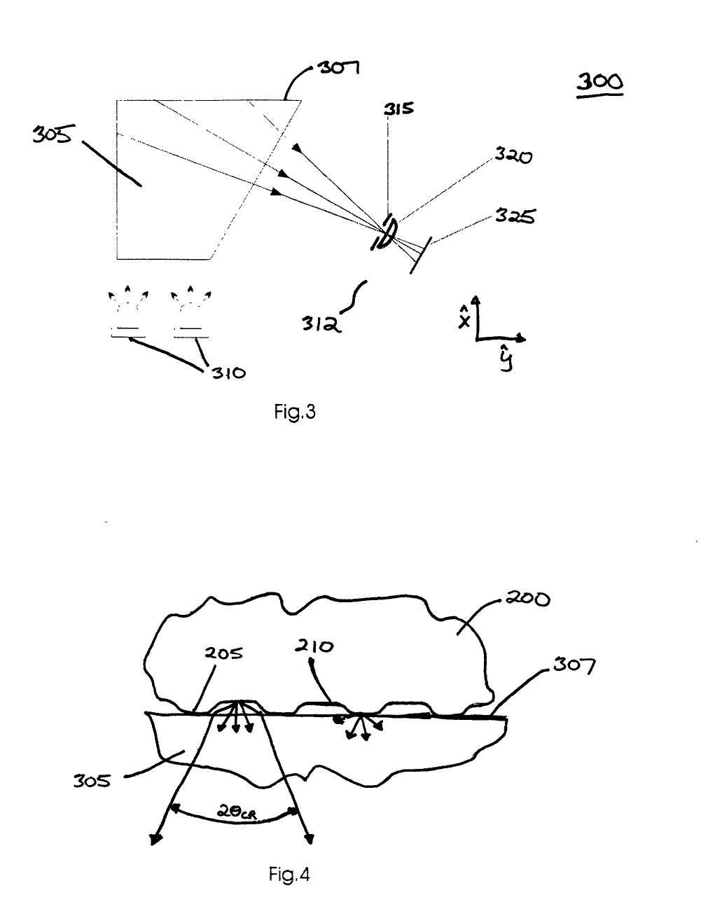

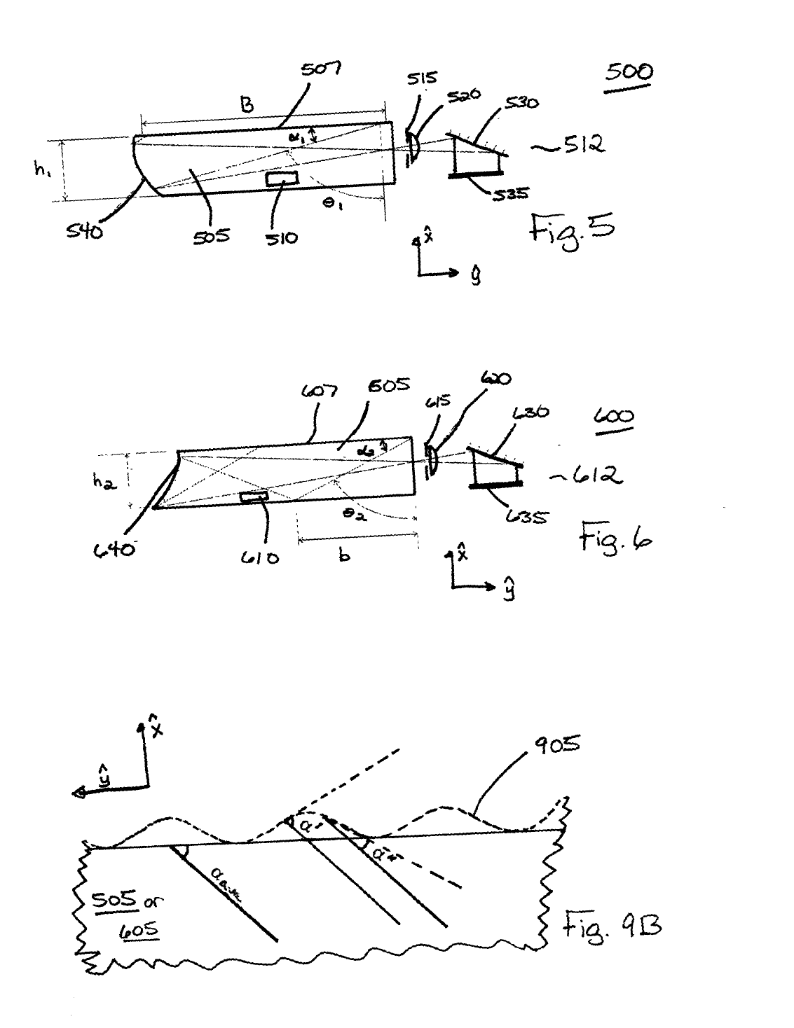

Referring to FIG. 5, in one implementation, a fingerprint imaging device 500 that produces a negative image, that is, a light fingerprint image on a dark background (similar in operation to the device 300 of FIGS. 3 and 4) includes an optical plate 505 having a surface 507 exposed to air and designed to receive a finger, one or more light sources 510 located along a lateral surface of the optical plate 505, and an imaging system 512. The fingerprint imaging device 500 produces a fingerprint pattern formed by regions of contact of finger skin ridges with the surface 507 of the optical plate 505. The imaging system 512 includes an aperture 515 located at another lateral surface, an objective 520, a reflective surface 530, such as a mirror, and some type of detector 535 for receiving light collected from the aperture 515 and the objective 520. The objective 520 is positioned to focus the reflected and/or diffused light rays from the surface 507 on the detector 535. The optical plate 505 also includes a reflective surface 540 such as a converging mirror positioned on another lateral surface of the optical plate 505 and opposite to the aperture 515.

The one or more light sources 510 may be arranged and operated to illuminate the surface 507. A light source 510 may be positioned at two opposite lateral surfaces of the optical plate 505. The light sources 510 may emit light in any wavelength region suitable for fingerprint imaging. In one implementation, the light sources 510 may be conventional light-emitting diodes emitting light in the red spectral region. In another implementation, the light sources 510 may emit evenly throughout a wide spectral range.

The reflective surface 530 may be any mirror coated to reflect light of a wavelength produced by the one or more light sources 510. The detector 535 may be, for example, a single crystal CMOS image sensor, produced by Motorola Co., Inc, or it may be a conventional array CCD. The optical plate 505, light sources 510, and detector 535 are chosen based on their various optical properties to provide the information needed to obtain fingerprint imaging results. Thus, for example, the optical plate 505 is selected based on its index of refraction and spectral transmission properties. The light sources 510 are selected based on their spectral emission and intensity properties. The detector 535 is selected based on its spectral detection, radiation intensity, and radiation sensitivity properties. The objective 520 may include, for example, a lens such as a planoconvex lens, which provides reasonable image quality at a reasonable cost. Alternatively, to reduce non-planarity of the image surface (which may arise when using the planoconvex lens), the objective 520 may include a biconcave or convexo-concave lens.

The surface 507 may be a smooth surface to provide good contact with the finger skin ridges. In any case, the surface 507 has dimensions that are sufficient for reliable identification of the fingerprint pattern. In other words, the surface 507 has dimensions sufficient to provide a number of ridge comparisons that enables reliable fingerprint identification. For example, the number of ridge comparisons may range anywhere from about 8 to about 16.

The reflective surface 540 may have a reflecting coating, which, for example, may be a deposited layer of aluminum. The reflective surface 540 may be made spherical to approximate a theoretically preferred parabolic or hyperbolic form. The reflective surface 540 may have a radius of curvature of about 36 mm and a center of curvature being offset by about 5 millimeters (mm) up from the center of the optical plate 505 along the x direction.

The objective 520 may have its object side focal point located approximately at the focal plane of the reflective surface 540. In this way, the objective 520 and the reflective surface 540 form an afocal optical system that may be physically adjusted to receive a substantially parallel beam of the light rays from the surface 507. Such an afocal optical system provides an image of the fingerprint pattern with minor geometric distortion notwithstanding high values of a path of observation. The object side focal point of the objective 520 may be located at a distance of about 1.5 mm from its plane surface facing the lateral surface at which the aperture is located.

The reflective surface 540 may be adjusted to receive substantially parallel light rays, (along an observation path given by θ₁) which are traveling from the surface 507 at the angle θ₁ with respect to the normal of the surface 507. The reflective surface 540 reflects the light rays through the optical plate 505 to the objective 520 as a converging beam. The objective 520 projects the fingerprint pattern image outside the optical plate 505 to the reflective surface 530. The reflective surface 530 directs the light rays emerging from the objective 520 to the detector 535. The detector 535 detects light rays that are incident on the reflective surface 540 and reflected from the surface 540.

The surface 507 and the air interface is defined by a critical angle θ_{CR1}, which is the smallest angle of incidence for which light striking the interface is totally internally reflected within the optical plate 505. The critical angle θ_{CR1} at this interface depends on the indices of refraction of the air and the optical plate 505. The value of the critical angle θ_{CR1} is given by Snell's Law as:

$$sin ( {θ}_{C R1} ) = \frac{{n}_{2}}{{n}_{1}} ,$$

where n₁ is the index of refraction of the optical plate 505 and n₂ is the index of refraction of air. Thus, if the optical plate 505 were made of acrylic, which has an index of refraction of 1.49, then the critical angle θ_{CR1} would be 42°. In that case, the angle of incidence (relative to the normal of the surface 507) of light striking the surface 507 need be less than 42° to permit negative fingerprint imaging of the fingerprint pattern.

Additionally, the surface 507 and the finger ridge interface is defined by a critical angle θ_{CR2}, which is the angle of incidece for which light striking the surface/ridge interface is totally internally reflected within the optical plate 505. Like critical angle θ_{CR1}, critical angle θ_{CR2} depends on the indices of refraction of the finger skin and the optical plate 505. The value of the critical angle θ_{CR2} is given by Snell's Law as:

$$sin ( {θ}_{C R2} ) = \frac{{n}_{3}}{{n}_{1}} ,$$

where n₃ is the index of refraction of the finger. Thus, if the finger skin has an index of refraction of 1.44, then the critical angle θ_{CR2} is 75.1°. Therefore, to permit negative fingerprint imaging of the fingerprint pattern, an angle of observation α₁ (equal to 90°−θ₁) relative to the surface 507 must be greater than a critical observation angle α₁, which equals 90°−the critical angle θ_{CR2}.

The optical plate 505 has a thickness h₁ that is measured along the x direction. This thickness h₁ is related to the angle θ₁ such that a light ray coming from a border of the surface 507 farthest from the reflective surface 540 must be captured by the reflective surface 540. As mentioned above, the angle θ₁ is related to the angle of observation α₁ by: θ₁=90°−α₁. The optical plate thickness may be reduced when the value of the angle θ₁ is near the critical angle θ_{CR2} at the optical plate interface with the finger skin.

The material of the optical plate 505 may have an index of refraction for a wavelength range that slightly exceeds the index of refraction for finger skin in that wavelength range. Thus, the optical plate 505 may be made of acrylic plastic, which, as noted, has an index of refraction of about 1.49 in the red wavelength region.

Referring also to FIG. 6, a fingerprint imaging device 600 is designed in many respects like the device 500. Thus, device 600 also produces a negative fingerprint image. The device 600 has an optical plate 605 having a surface 607, one or more light sources 610 located along a lateral surface of the optical plate 605, and an imaging system 612. The imaging system 612 includes an aperture 615 located at another lateral surface of the optical plate 605, an objective 620, a reflective surface 630 such as a mirror, and a detector 635. The optical plate 605 also includes a reflective surface 640 positioned on another lateral surface of the optical plate 605 and opposite to the aperture 615. Unlike the optical plate 505, the reflective surface 640 may be a diverging mirror.

The material of the optical plate 605 may be chosen such that its index of refraction for a wavelength range slightly exceeds the index of refraction for finger skin in that wavelength range. The index of refraction for finger skin has been measured to be approximately 1.44. Thus, the optical plate 605 may be made of acrylic plastic, which has an index of refraction of 1.49 in the red wavelength region.

In operation, when a finger is applied to the surface 507, 607, light rays from the light sources 510, 610 penetrate through the surface 507, 607 and illuminate the finger at its ridges in those portions of the surface 507, 607 that are contacted by the ridges of the finger. Light rays diffused at the ridges pass through the optical plate 505, 605. These light rays create a negative fingerprint pattern formed by the bright regions corresponding to the ridges of the finger skin because the valleys of the finger skin produce a dark background. In this way, the imaging system 512 or 612 detects a light fingerprint image formed on a dark background. To reduce the thickness h₁ or h₂ of the device 500 or 600, the observation angle α_{1,2} should be decreased (or the angle θ_{1,2} should be increased. However, if the angle θ₁, θ₂ exceeds the critical angle θ_{CR2}, the fingerprint image disappears. If the optical plate were made of acrylic plastic having an n₁=1.49 and if the measure of the index of refraction of the finger n₂=1.44, then the observation angle α_{1,2} has a minimum value of 14.9°, which is the critical observation angle α_{CR} (or 90°−θ_{CR2}).

For device 500 having a reflective surface 540 that is a converging mirror, the minimum thickness h₁ is related to the critical observation angle α_{CR} by the following general relationship:

$$tan ( {α}_{C R} ) = \frac{{h}_{1}}{B} ,$$

where B is a length of the fingerprint that can be captured. When B=16 mm and α_{CR}=14.9°, the minimum thickness h₁=4.26 mm.

In the device 600, a double reflection occurs due to the use of the reflective surface 640 that is a diverging mirror. Such a design allows a further reduction of the thickness of the device 600. In this case, the minimum thickness h₂ is related to the critical observation angle α_{CR} by the following general relationship:

$$tan ( {α}_{C R} ) = \frac{{h}_{2}}{b} ,$$

where b is a length of the fingerprint that can be captured. Thus, if b=13.5 mm and α_{CR}=14.9°, then the minimum thickness h₂=3.6 mm.

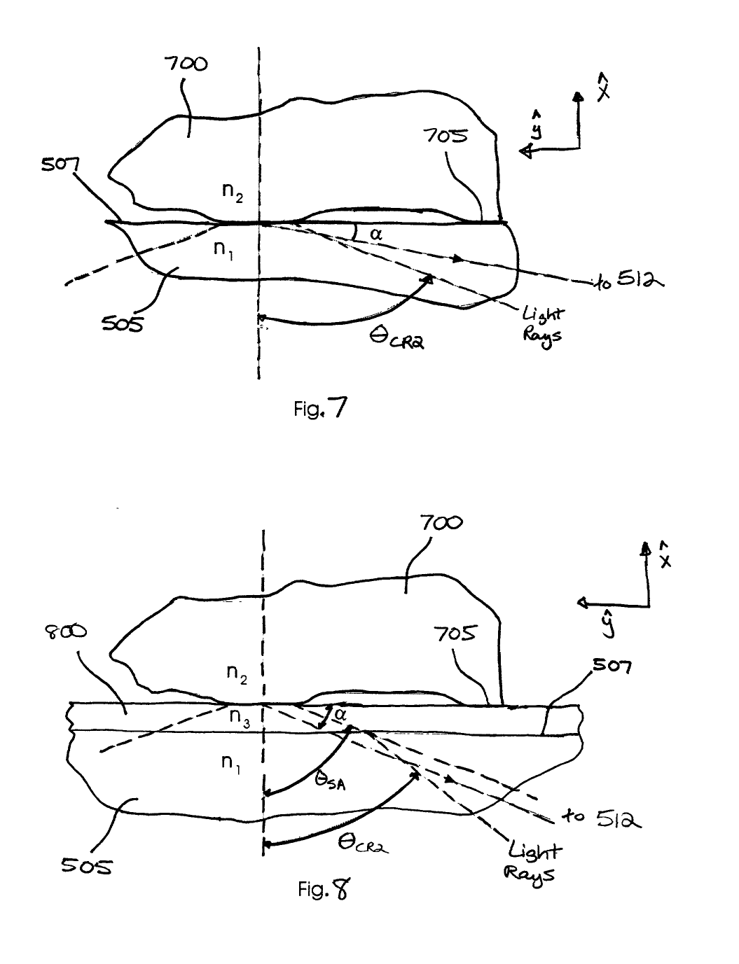

Referring also to FIG. 7, a portion of the optical plate 505 is shown when a finger 700 is applied to the surface 507. Light rays from the light sources 510 diffuse at a ridge 705 of the finger 700 and these diffused rays propagate through the optical plate 505 within a solid angle 2θ_{CR2}, where, as noted above, sin(θ_{CR2})=n₂/n₁, n₂ is the measure of the index of refraction of the finger 700, and n₁ is the index of refraction of the optical plate 505. To reduce the thickness of the fingerprint imaging device 500, the imaging system 512 may be configured to accept light rays traveling at an observation angle α less than or equal to the critical observation angle α_{CR}=90°−θ_{CR2} to detect the diffused light rays from the ridges 705. Thus, in this configuration, the light rays that travel at an observation angle α greater than the critical observation angle α_{CR} fail to reach the imaging system 512. This can also be a problem when using the optical plate 605.

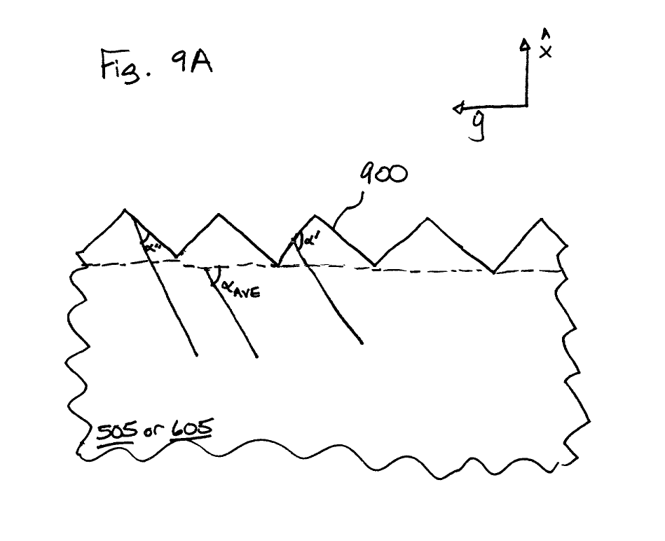

In an attempt to permit this reduction in the thickness, and referring also to FIG. 8, an optical material 800 may be deposited along at least a portion of the surface 507 of the optical plate 505. If the optical material 800 is made of a material having an index of refraction n₃ that is less than the index of refraction n₁ of the optical plate 505, that is n₃<n₁, then light rays diffused from the ridges 705 propagate through the material 800 within a solid angle θ_{SA} that is greater than the solid angle θ_{CR2}. However, the light rays refract at the optical material/optical plate interface because the index of refraction changes from n₃ to n₁ along this interface. Thus, in this configuration, as with the configuration shown in FIG. 7, the light rays continue to propagate through the optical plate 505 within the solid angle θ_{CR2} and do not reach the imaging system 512, which is positioned at an angle of observation α that is less than the critical observation angle α_{CR}. This can also be a problem when using the optical plate 605 and if the optical material 800 is deposited along at least a portion of the surface 607 of the optical plate 605.

Thus, if the thickness of the optical plate is reduced without implementing any special means like, for example, changing the shape of the surface of the optical plate, problems of observing the fingerprint image emerge in both cases—whether or not a coating is deposited on the finger-receiving surface of the optical plate. To enable observation of the fingerprint image when the thickness of the fingerprint imaging device is reduced, the surface of the optical plate may be formed as an array of microstructures, for example, microprisms.

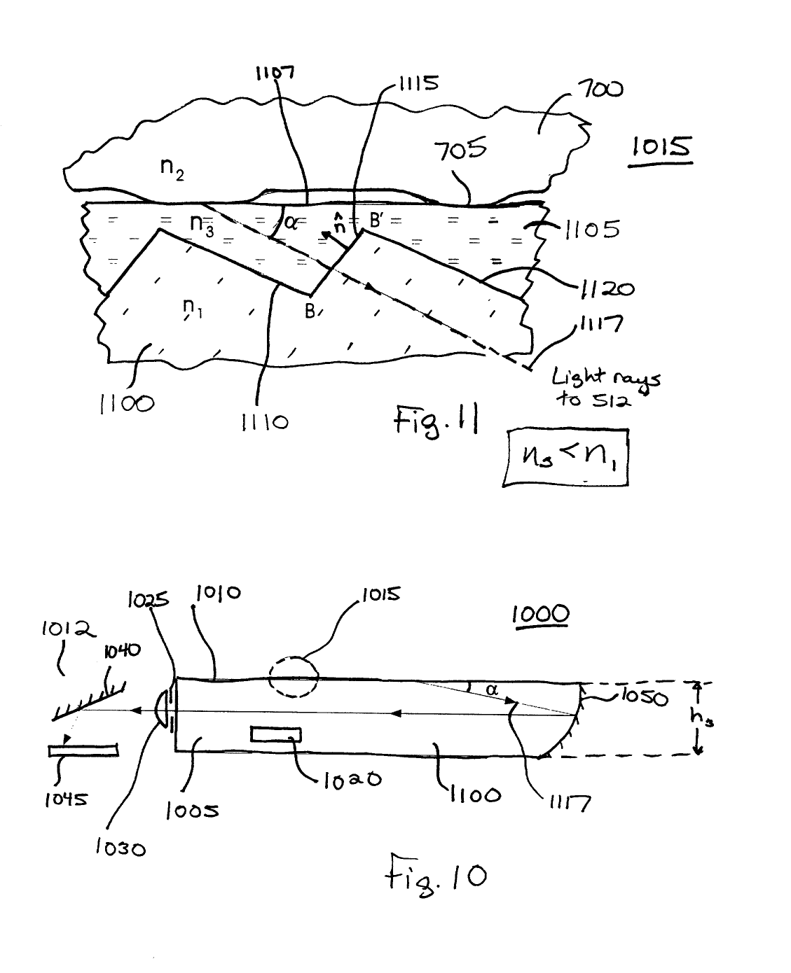

Referring also to FIGS. 9A and 9B, in one implementation, the surface of the optical plate 505, 605 may include one or more microstructures (for example, projections and/or depressions) such as triangles 900 (FIG. 9A) or waves 905 (FIG. 9B) formed along the z direction of the surface. In this way, observation angles α′ and α″ along each side (or facet) of a microstructure are greater than or lesser than an average observation angle αₐᵥₑ, which approximates the observation angle α_{1,2} that is discussed above. In particular, the critical observation angle αₐᵥₑ is the average value of the observation angle α_{1,2} for a relatively flat surface (such as surfaces 507, 607). Thus, α′>αₐᵥₑ and α″<αₐᵥₑ. In this configuration, the fingerprint is visible along the sides of the microstructures at which α′>αₐᵥₑ. The resulting image at the detector is invisible at certain portions of the image separated by a period that depends on the period at which the microstructures repeat. In any case, the fingerprint will be interpreted by the detector as a continuous pattern.

As is evident from the description of the optical plate, the microstructures may have a shape different from that of triangles or waves. For example, microstructures may be fabricated as smoothed riffles or “dot” projections, being near-conical or near-spherical shaped. The microstructures may be fabricated as parallel rows of semicircular Fresnel type lens. Examples of microstructures that may be used are shown in U.S. Pat. No. 6,069,969 to Keagy et al., which is incorporated herein by reference.

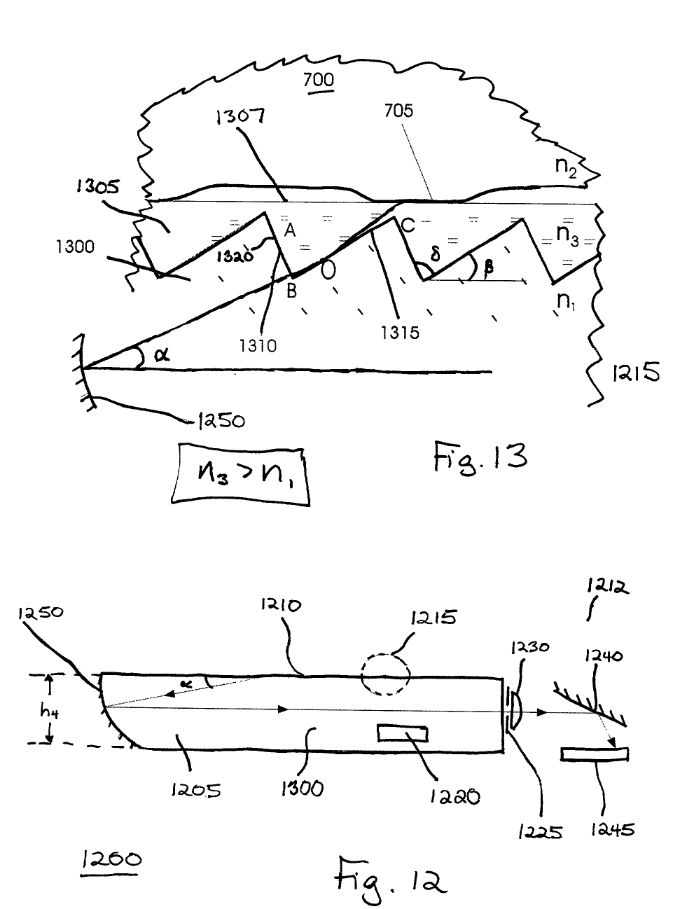

To permit a reduction in the thickness of the fingerprint imaging device, the microstructures may be covered with a coating having an index of refraction less than the index of refraction of the optical plate, as shown in the fingerprint imaging device 1000 of FIGS. 10 and 11. The fingerprint imaging device 1000 includes an optical plate 1005 generally having a surface 1010, a portion 1015 of which is detailed in FIG. 11. The surface 1010 provides light propagation along an observation path at a reduced thickness h₃ as compared with the minimum thickness of devices 500 or 600. The device 1000 is otherwise like device 500 or 600. Accordingly, the device 1000 also includes one or more light sources 1020 located along a lateral surface of the optical plate 1005, and an imaging system 1012. The imaging system 1012 includes an aperture 1025, an objective 1030, a reflective surface 1040, such as a mirror, and some type of detector 1045. The optical plate 1005 also includes a reflective surface 1050 such as a spherical converging mirror, as shown, or a diverging mirror, positioned on another of its lateral surfaces.

The optical plate 1005 includes a base 1100 made of an optically transparent material (such as, for example, an acrylic plastic) having an index of refraction n₁ and a coating 1105 deposited on at least a portion of the base to form a surface 1107 for receiving the finger 700. The coating 1105 has an index of refraction n₃ that is less than the index of refraction n₁ of the base 1100. Moreover, the coating 1105 is made of an optically transparent material. The coating 1105 may be made of a material that includes silicone. Or, the coating 1105 may be made of epoxy resin, such as epoxy resin marketed under the trade name EMCAST by Electronic Materials, Inc., of Breckenridge, Co. The coating 1105 may be made of an elastic material. Depending on its material, the coating 1105 may improve contact between the finger and the surface of the coating 1105.

The base 1100 includes an array of microstructures 1110 (such as the designs shown in FIGS. 9A and 9B). The microstructures 1110 are configured so that one surface 1115 (given by line BB′) is tilted relative to the other surface 1120 (for example, at a 90° angle). In this case, the normal \hat{n} to surface 1115 is substantially parallel to the observation path (given by 1117) of the imaging system 1012. Thus, light that reaches the imaging system 1012 strikes the surface 1115 at an angle that substantially coincides with a normal to the surface 1115. In this way, the light rays diffused by the finger ridges 705 at the surface 1107 and traveling at the observation angle α are not refracted at the coating/base interface. Thus, the light rays traveling at the observation angle α, upon reflection from the ridge 705, reach the imaging system 1012 even though the observation angle α is less than the critical observation angle αₐᵥₑ, as shown in FIG. 9B.

In one implementation, the base 1100 may be made of acrylic plastic having an index of refraction n₁=1.49 and having a surface 1010 with dimensions 17×17 mm and having a height h₃=3.5 mm. The reflective surface 1050 may be a spherical mirror having a 36 mm radius of curvature. The coating 1105 is made of a material having an index of refraction n₃=1.41. Using these parameters, the angle α=12.3°.

In operation, light from the light sources 1020 strikes the ridges 705 and is diffused into the coating 1105 at a solid angle of 180° because the index of refraction n₃ for the coating 1105 is less than a measured value of the index of refraction of the finger n₂. The light rays diffused at the angle α pass across the surfaces 1115 of the microstructures 1110 without being refracted and strike the aperture 1025 after being reflected by the reflective surface 1050. The finger image is formed on the surface of the detector 1045 using the objective 1030 and the reflective surface 1040.

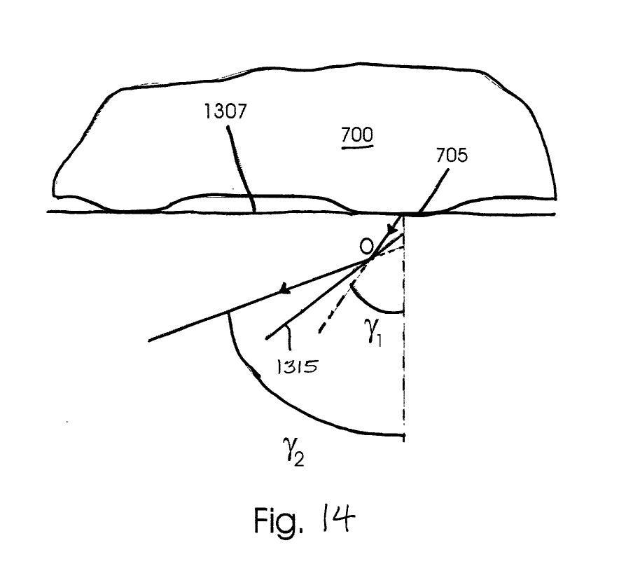

Referring also to FIGS. 12 and 13, a fingerprint imaging device 1200 includes an optical plate 1205 generally having a surface 1210, a portion 1215 of which is detailed in FIG. 13. The surface 1210 provides light propagation along the observation path at a reduced thickness h₄ of the device 1200. The device 1200 is like device 500 or 600. Accordingly, the device 1200 also includes one or more light sources 1220 located along a lateral surface of the optical plate 1205, and an imaging system 1212. The imaging system 1212 includes an aperture 1225, an objective 1230, a reflective surface 1240, such as a mirror, and some type of detector 1245. The optical plate 1205 also includes a reflective surface 1250 such as a spherical converging mirror positioned on another of its lateral surfaces.

The optical plate 1205 includes a base 1300 made of an optically transparent material (such as, for example, an acrylic plastic) having an index of refraction n₁ and a coating 1305 deposited on at least a portion of the base 1300 to form a surface 1307 for receiving the finger 700. The coating 1305 has an index of refraction n₃ that is greater than the index of refraction n₁ of the base 1300. Moreover, the coating 1305 is made of any optically transparent material. The coating 1305 may be made of an elastic material to improve contact between the finger and the surface of the coating 1305.

The base 1300 includes an array of microstructures 1310 (such as, for example, the designs shown in FIGS. 9A and 9B) to permit observation angles α beyond the critical observation angle αₐᵥₑ. The microstructures 1310 are configured so that one surface 1315 is tilted relative to the other surface 1320. In this case, the surface 1320 is substantially perpendicular to the observation path of the imaging system 1212. Thus, light strikes the surface 1320 at an angle that substantially coincides with a normal to the surface 1320.

Referring also to FIG. 14, because the index of refraction n₃ of the coating 1305 is greater than the index of refraction n₁ of the base 1300, light from the finger that strikes surface 1315 at an angle γ₁ greater than the critical angle for the coating/base interface totally internally reflects at point O. The reflected light from point O travels an angle γ₂ that is greater than the critical angle for the coating/base interface. In this way, light reflecting at point O strikes surface 1320 at an angle substantially perpendicular (that is, within a reasonable range of angles near 90°) to the surface 1320 and follows the observation angle α to reach the imaging system 1212. The light rays traveling at the angle γ₁ upon reflection from the ridge 705 reach the imaging system 1212 even though the angle γ₁ is greater than the critical angle. The finger image is formed on the surface of the detector 1245 using the objective 1230 and the reflective surface 1240.

Surface 1315 and surface 1310 are positioned to limit deviation of light reflected at the observation angle α due to refraction at the surface 1320. The material for the coating 1305 is chosen to have a refractive index n₃ that provides total internal reflection at the surface 1315, that is, any material in which the refractive index n₃ is greater than the refractive index n₁. Examples of such materials include various forms of glass or plastic that may be available from manufacturers. For example, some forms of acrylic have a suitable index of refraction.

In one implementation, the base 1300 may be made of acrylic plastic having an index of refraction n₁=1.49, the coating 1305 may be made of a a glass or plastic material having an index of refraction n₃=1.543. At such values, the angle subtended by surface 1315 and surface 1320 may be 90° and the optical plate 1205 has a height h₄=3.8 mm.

The detector requires a minimum amount of information to image a fingerprint without sacrificing information about individual characteristics of ridge configuration and without sacrificing an accurate or precise identification of the fingerprint. Typically, this amount of information is measured using a spatial period of the fingerprint pattern. For a direction transverse to ridges (that is, in a direction along the plane y-z), a typical value of a period of the fingerprint pattern is in the range of about ½ mm to about ¼ mm.

The microstructures are also defined by a period along the z direction. The period of microstructures relates to the amount of information processed by the detector for imaging the fingerprint. Accordingly, the minimum amount of information required by the detector correlates to a maximum period of the microstructures. The maximum period of microstructures should not exceed about half of the minimum spatial period, which is about ¼ mm. Thus, the maximum period of microstructures is bound by a value of ⅛ mm or approximately 0.1 mm.

In practice, the period of microstructures is near this maximum period because the relative dimension of the contact portions of ridges with the surface decreases as the period of microstructures decreases. This occurs because the finger skin has a limited amount of elasticity.

In one implementation, the period of microstructures is about 0.05 mm and a length of surface 1115 or 1120 is near 0.025 mm when it is assumed that the surfaces 1115 and 1120 have equal sizes (which in practice may not be the preferred design).

A number of implementations have been described. Nevertheless, it will be understood that various modifications may be made without departing from the spirit and scope of the invention. For example, advantageous results still could be achieved if steps of the disclosed techniques were performed in a different order and/or if components in the disclosed systems were combined in a different manner and/or replaced or supplemented by other components. Accordingly, other embodiments are within the scope of the following claims.

For example, the light sources of the fingerprint imaging device may be light-emitting bars or compact filament lamps. The optical plate may be made of polystyrene or any glass or plastic having an index of refraction that slightly exceeds the index of refraction for the finger skin in a wavelength range given by the wavelength range at which the light sources emit radiation and the wavelength range at which the imaging system detects radiation.

What is claimed is:

1. An imaging device comprising:
an optical plate including:
a base made of an optically transparent material and having an index of refraction, the base including an array of microstructures along a first surface, and
a coating deposited on the first surface of the base and forming a surface for receiving a finger, the coating having an index of refraction that is different from the index of refraction of the base; and
an imaging system positioned at a second surface of the base to receive light from the finger at an observation angle measured relative to the finger receiving surface and to form an image of a fingerprint pattern of the finger based on the received light.

2. The device of claim 1 further comprising a light source at a third surface of the base to illuminate the first surface of the base.

3. The device of claim 2 in which the third surface is perpendicular to the first surface.

4. The device of claim 1 in which the index of refraction of the coating is less than the index of refraction of the base.

5. The device of claim 4 in which each microstructure comprises a surface that is substantially perpendicular to an observation path such that light from the finger strikes the microstructure surface at an angle substantially perpendicular to the microstructure surface.

6. The device of claim 1 in which the array of microstructures is defined by a spatial period that is approximately two times greater than a maximum spatial period of ridges in an average fingerprint pattern.

7. The device of claim 1 in which the coating comprises silicone.

8. The device of claim 1 in which the base includes a spherically-shaped reflective surface positioned along a fourth surface that is approximately lateral to the first surface.

9. The device of claim 8 in which the spherically-shaped reflective surface collects light from the finger onto the imaging system positioned at the second surface.

10. The device of claim 8 in which the spherically-shaped reflective surface is formed from a converging mirror.

11. The device of claim 8 in which the spherically-shaped reflective surface is formed from a diverging mirror.

12. The device of claim 1 in which the imaging system comprises:
an aperture;
an objective at the aperture; and
a detector for receiving light collected by the aperture and the objective to form the image of the fingerprint pattern.

13. The device of claim 12 in which the imaging system comprises a reflective surface positioned between the objective and the detector for collecting light from the objective and for focusing the light onto the detector.

14. The de vice of claim 12 in which the detector comprises a CCD.

15. The device of claim 12 in which the detector comprises a CMOS sensor.

16. The device of claim 12 in which the aperture defines an aperture beam of light rays used by the detector to form the fingerprint pattern image.

17. The device of claim 1 in which the index of refraction of the coating is greater than the index of refraction of the base.

18. The device of claim 17 in which each microstructure comprises a first surface and a second surface that are positioned such that light striking the first surface at an angle that is greater than the critical total internal reflection angle for the coating and the base interface reflects from the first surface and strikes the second surface at an angle that substantially coincides with a normal to the second surface.

19. A method of imaging a fingerprint, the method comprising:
providing an optical plate that includes:
a base made of an optically transparent material and having an index of refraction, the base including an array of microstructures along a first surface, and
a coating deposited on the first surface of the base and forming a surface for receiving a finger, the coating having an index of refraction that is different from the index of refraction of the base;
receiving a finger at the finger receiving surface;
illuminating the finger receiving surface with a light source;
collecting light from the finger receiving surface;
receiving the collected light at an imaging system positioned at a second surface of the base, the received light traveling at an observation angle measured relative to the finger receiving surface; and
forming an image of a fingerprint pattern of the received finger based on the received light.

20. The method of claim 19 further comprising positioning the light source at a third surface of the base, the third surface being perpendicular to the finger receiving surface.

21. The method of claim 19 in which each microstructure comprises a surface that is perpendicular to an observation path.

22. The method of claim 19 in which the array of microstructures is defined by a spatial period that is approximately two times greater than a maximum spatial period of ridges in an average fingerprint pattern.

23. The method of claim 19 in which collecting light from the finger includes collecting the light from the finger onto the imaging system.

24. The method of claim 19 in which the imaging system includes an aperture, an objective at the aperture, and a detector.

25. The method of claim 24 in which receiving light at the imaging system comprises defining an aperture beam of light rays with the aperture and focusing the aperture beam of light onto the detector with the objective.

26. The method of claim 19 in which the index of refraction of the coating is less than the index of refraction of the base.

27. The method of claim 26 in which each microstructure comprises a surface having a normal that substantially coincides with an observation path such that light from the finger strikes the microstructure surface at an angle that substantially coincides with a normal of the microstructure surface.

28. The method of claim 19 in which the index of refraction of the coating is greater than the index of refraction of the base.

29. The method of claim 28 in which each microstructure comprises a first surface and a second surface that are positioned such that light from the finger strikes the first surface at an angle that is greater than the critical total internal reflection angle for the coating and the base interface and reflects from the first surface and strikes the second surface at an angle that substantially coincides with a normal to the second surface.

30. An optical plate for use in an imaging device, the optical plate comprising:
a base made of an optically transparent material and having an index of refraction, the base including an array of microstructures along a first surface; and
a coating deposited on the first surface of the base and forming a surface for receiving a finger, the coating having an index of refraction that is different from the index of refraction of the base.

31. The optical plate of claim 30 in which the base includes a second surface for coupling to an imaging system and the base transmits light into the imaging system from the finger at an observation angle measured relative to the surface of the coating.

32. The optical plate of claim 30 in which the index of refraction of the coating is less than the index of refraction of the base.

33. The optical plate of claim 32 in which each microstructure comprises a surface that is substantially perpendicular to an observation path such that light from the finger strikes the microstructure surface at an angle substantially perpendicular to the microstructure surface.

34. The optical plate of claim 30 in which the index of refraction of the coating is greater than the index of refraction of the base.

35. The optical plate of claim 34 in which each microstructure comprises a first surface and a second surface that are positioned such that light striking the first surface at an angle that is greater than the critical angle for the coating and the base interface reflects from the first surface and strikes the second surface at an angle that substantially coincides with a normal to the second surface.
